(19) United States
(12) Patent Application Publication
(10) Pub. No.: US 2025/0034917 A1
(43) Pub. Date: Jan. 30, 2025

(54) CONTROL ASSEMBLY FOR OPERATING A MOTOR VEHICLE CLOSING SYSTEM

(71) Applicant: Brose Fahrzeugteile SE & Co. Kommanditgesellschaft, Bamberg, Bamberg (DE)

(72) Inventor: Florian Pohl, Ebersdorf (DE)

(21) Appl. No.: 18/717,175

(22) PCT Filed: Dec. 5, 2022
(86) PCT No.: PCT/EP2022/084448

§ 371 Date: Jun. 6, 2024

(30) Foreign Application Priority Data
Dec. 7, 2021 (DE) 10 2021 132 203.0

(51) Int. Cl. E05B 81/86; E05B 81/58

(52) U.S. Cl. CPC E05B 81/86; E05B 81/58

(57) ABSTRACT

A control arrangement for operating a vehicle locking system, the vehicle locking system having a drive with an electric drive motor, the control arrangement actuating the drive in response to a trigger signal transmitted by an operating element to provide a motorized locking function for an adjustable closure element of the motor vehicle, the control arrangement having an electrical energy store and a supply circuit associated with the energy store, the supply circuit, during emergency operation in response to the trigger signal being received by the supply circuit, providing an emergency supply voltage to the drive via the energy store. The control arrangement has a limiting member for the forwarding of the trigger signal from the operating element to the supply circuit, and that the limiting member is designed to suppress the forwarding of the trigger signal after a maximum actuation time has elapsed following beginning of the trigger signal.

### CROSS-REFERENCE TO RELATED APPLICATIONS

This application is a national stage application under 35 U.S.C. 371 of International Patent Application Serial No. PCT/EP2022/084448, entitled “Control Assembly for Operating a Motor Vehicle Closing System,” filed Dec. 5, 2022, which claims priority from German Patent Application No. DE 10 2021 132 203.0, filed Dec. 7, 2021, the disclosure of which is incorporated herein by reference.

### FIELD OF THE TECHNOLOGY

Various embodiments relate to a control arrangement for operating a motor vehicle locking system, to a motor vehicle locking system for a motor vehicle, and to a method for operating a motor vehicle locking system.

### BACKGROUND

The known control arrangement (DE 10 2020 102 775 A1) on which some embodiments are based relates, amongst other things, to the operation of a motor vehicle locking system having a motor vehicle lock which has a lock latch and a pawl as locking elements. The lock latch can be moved to a locking position in which it is in holding engagement with the locking part and in which it is fixed by the pawl. The motor vehicle lock is furthermore equipped with an electric drive, by way of which the pawl can be lifted, so that the lock latch, so as to release the locking part, can be adjusted to its open position. For this purpose, the operator operates an operating element, for example a door handle, which transmits a trigger signal to the control arrangement. In response to receiving the trigger signal, the control arrangement actuates the drive.

In order to be able to take into account the requirements in respect of ensuring the voltage supply to such motor vehicle locking systems, the known control arrangement is equipped with a rechargeable energy store, as a result of which the voltage supply to the motor vehicle locking system is ensured even during emergency operation, in particular if a central battery of the motor vehicle fails. For this purpose, an emergency supply voltage is provided from the energy store to the drive in response to the trigger signal being received by a supply circuit.

Maintaining charging of the energy store is of particular relevance in this respect since the energy store remains the only energy source for the motor vehicle locking system during emergency operation in many cases.

### SUMMARY

Various embodiments are based on the problem of configuring and developing the known control arrangement in such a way that the energy store is further protected against unintentional discharging.

The above problem is solved by various features described herein.

The motor vehicle locking system in question is used with all types of motorized locking functions for closure elements of a motor vehicle. These include, in particular, the locking functions of motor vehicle locks for closure elements such as side doors, rear doors, tailgates, trunk lids or engine hoods. These closure elements may be configured, in principle, as pivoting or sliding doors. Further examples of the locking functions in question of a motor vehicle are drive arrangements that provide motorized adjustment, in particular of the abovementioned closure elements.

Various embodiments proceed from the knowledge that a faulty trigger signal, which is caused by a defective operating element or a damaged feed line for example, can lead to premature discharging of the energy store. In particular, a hanging operating element that permanently transmits a trigger signal can lead to rapid discharging of the energy store since the supply circuit is kept active. The concept of a long-lasting trigger signal therefore being suppressed by the control arrangement after a certain time period, whereby the supply via the energy store is reliably ended after actuation, is essential.

Specifically, various embodiments provide that the control arrangement has a limiting member for the forwarding of the trigger signal from the operating element to the supply circuit, and that the limiting member is designed to suppress the forwarding of the trigger signal after a maximum actuation time has elapsed following beginning of the trigger signal.

Particularly robust and cost-effective implementation of the limiting member is provided in various embodiments via a filter circuit and in particular via a high-pass filter, whereby switching elements are not absolutely necessary for suppressing the trigger signal.

In addition, the use of a pull-up resistor as provided in various embodiments, which can be likewise used as part of the filter circuit, in order to reduce the number of components required is particularly advantageous.

A particularly simple refinement which can be parameterized with respect to the maximum actuation time is additionally specified in various embodiments, according to which the limiting member is based on a monostable multivibrator.

In general, a switching element for suppression, which is in turn actuated by a time controller, can be provided in various embodiments.

The switching element used in various embodiments is a logic member, in particular even a single logic gate, as a result of which the actuation via the time controller can be implemented in a simple manner.

In various embodiments, the time controller is formed via a delay circuit, so that in particular cost-effective components such as a delay member can be used for implementing the maximum actuation time.

Various embodiments relate to a further refinement having a switching element designed as a multiplexer, as a result of which in particular the logic level can be directly defined at the input of the supply circuit.

In various embodiments, a processor which is in particular already provided for actuating the drive is also used for implementing the limiting member. Here, the processor can provide in particular the time controller for the switching element, whereby the time controller can be implemented in a flexible manner, for example by programming for the processor.

In various embodiments, the time controller has a storage member which maintains the suppression of the forwarding of the trigger signal even when further components of the time controller, in particular of the processor, are deactivated. Therefore, in particular during the emergency operation in question here, the functioning of the limiting member is ensured with a high degree of reliability, for example even when the processor is not operated at times.

In various embodiments, the supply circuit has a boost converter, for example for at least one storage capacitor of the energy store, which is activated via the trigger signal. Here, the limiting member ensures that the boost converter switches off in good time even in the case of a faulty and permanent trigger signal.

Various embodiments provide a motor vehicle locking system for a motor vehicle having a drive with an electric drive motor for providing a motorized locking function for an adjustable closure element of the motor vehicle and having a control arrangement as proposed.

Various embodiments provide a method for operating a motor vehicle locking system.

It can be here that the control arrangement has a limiting member for the forwarding of the trigger signal from the operating element to the supply circuit, the forwarding of the trigger signal being suppressed by means of the limiting member after a maximum actuation time has elapsed following beginning of the trigger signal.

Reference may be made to all embodiments relating to the control arrangement.

Various embodiments provide a control arrangement for operating a motor vehicle locking system, the motor vehicle locking system having a drive with an electric drive motor, the control arrangement actuating the drive in response to a trigger signal transmitted by an operating element in order to provide a motorized locking function for an adjustable closure element of the motor vehicle, the control arrangement having an electrical energy store and a supply circuit associated with the energy store, the supply circuit, during emergency operation in response to the trigger signal being received by the supply circuit, providing an emergency supply voltage to the drive via the energy store, wherein the control arrangement has a limiting member for the forwarding of the trigger signal from the operating element to the supply circuit, and wherein the limiting member is designed to suppress the forwarding of the trigger signal after a maximum actuation time has elapsed following beginning of the trigger signal.

In various embodiments, the limiting member has at least one filter circuit, such as a high-pass filter, for suppressing the trigger signal.

In various embodiments, the control arrangement has a pull-up resistor which provides a high logic level for the supply circuit, and wherein the supply circuit receives a low logic level with forwarding of the trigger signal. In various embodiments, the pull-up resistor is part of the filter circuit.

In various embodiments, the limiting member has a monostable multivibrator which is designed to be moved to an unstable state, in which the forwarding of the trigger signal is allowed by the limiting member, when the trigger signal is received, and to fall back to a stable state, in which the forwarding of the trigger signal is suppressed by the limiting member, after the maximum actuation time has elapsed.

In various embodiments, the limiting member has a switching element which allows the forwarding of the trigger signal in a first switching state and suppresses the forwarding of the trigger signal in a second switching state, and wherein a time controller is provided for actuating the switching element, the time controller moving the switching element to the second switching state after the maximum actuation time has elapsed.

In various embodiments, the switching element has a logic member which receives the trigger signal at an input and is interconnected with the time controller at a further input for actuation, and wherein the output of the logic member is provided for forwarding the trigger signal.

In various embodiments, the time controller has a delay circuit, and wherein the delay circuit contains at least one logic circuit, which has a propagation time configured for providing the maximum actuation time, and/or a delay member.

In various embodiments, the switching element is configured as a multiplexer.

In various embodiments, the control arrangement has a processor, in particular for actuating the drive, and the processor provides or actuates the limiting member. In various embodiments, the processor at least partially provides the time controller for the switching element.

In various embodiments, the time controller has a storage member, such as an RC flip-flop, which maintains the actuation of the switching element for suppressing the trigger signal.

In various embodiments, the supply circuit has a boost converter which can be activated by the trigger signal. In various embodiments, the energy store has at least one storage capacitor, such as at least one double-layer capacitor.

Various embodiments provide a motor vehicle locking system for a motor vehicle having a drive with an electric drive motor for providing a motorized locking function for an adjustable closure element of the motor vehicle and having a control arrangement as provided herein.

Various embodiments provide a method for operating a motor vehicle locking system, the motor vehicle locking system having a drive with an electric drive motor, the drive being actuated by means of the control arrangement in response to a trigger signal transmitted by an operating element in order to provide a motorized locking function for an adjustable closure element of the motor vehicle, the control arrangement having an electrical energy store and a supply circuit associated with the energy store, during emergency operation in response to the trigger signal being received an emergency supply voltage being provided to the drive via the energy store by means of the supply circuit, wherein the control arrangement has a limiting member for the forwarding of the trigger signal from the operating element to the supply circuit, the forwarding of the trigger signal being suppressed by means of the limiting member after a maximum actuation time has elapsed following beginning of the trigger signal.

### BRIEF DESCRIPTION OF THE DRAWINGS

Various aspects will be explained in more detail below with reference to a drawing which merely illustrates exemplary embodiments. In the drawing

FIG. 1 shows a schematic, perspective illustration of a motor vehicle having a motor vehicle locking system as proposed, which has a motor vehicle lock, and the motor vehicle lock in a partially disassembled side view,

FIG. 2 shows a schematic illustration of the control arrangement as proposed, and

FIGS. 3 a) to d) show various refinements of the limiting member.

### DETAILED DESCRIPTION

Various embodiments relate to a control arrangement 1 for a motor vehicle locking system 2. The motor vehicle locking system 2 has a drive 3 with an electric drive motor 4.

The control arrangement 1 actuates the drive 3 in response to a trigger signal transmitted by an operating element 5 in order to provide a motorized locking function for an adjustable closure element 6 of the motor vehicle.

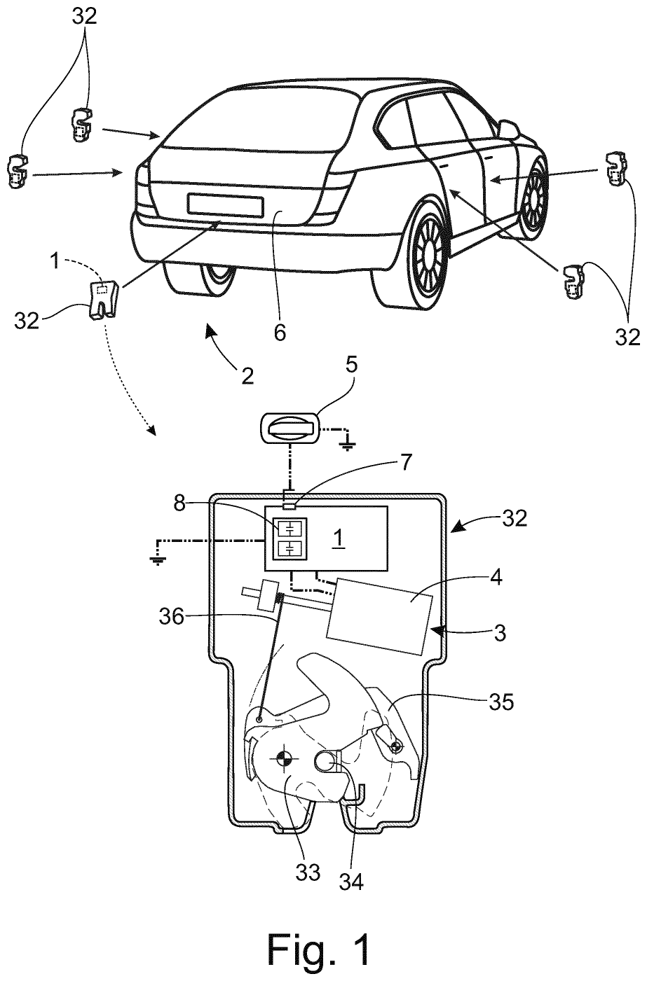

A motorized locking function should be understood to mean that an adjustable closure element 6 of the motor vehicle is adjusted directly or indirectly by movement generated by the electric drive 3, for example is opened or closed and/or is locked or unlocked. The exemplary embodiment illustrated in FIG. 1 of the motor vehicle locking system 2 is associated with the tailgate as a closure element 6. In principle, all explanations also apply to all other types of closure elements 6, reference additionally being made to the statements made in the introductory part.

The trigger signal is transmitted by the operating element 5 to the control arrangement 1. In various embodiments, the operating element 5 has a door handle. The operating element 5 is equipped with a sensor or the like which detects operation of the door handle and forwards the detection to the control arrangement 1 via a control connection. The trigger signal may be, in principle, one of various types of control signals, the trigger signal not necessarily having to be time-dependent. Rather, the trigger signal may also be understood to mean an electric potential in a predetermined range. In various embodiments, provision is made for a connecting input 7 of the control arrangement 1 for the trigger signal to be set to a low logic level, further to ground, when the operating element 5 is operated. Here, it is further in particular the case that the trigger signal is ended when the operation of the operating element 5 is ended.

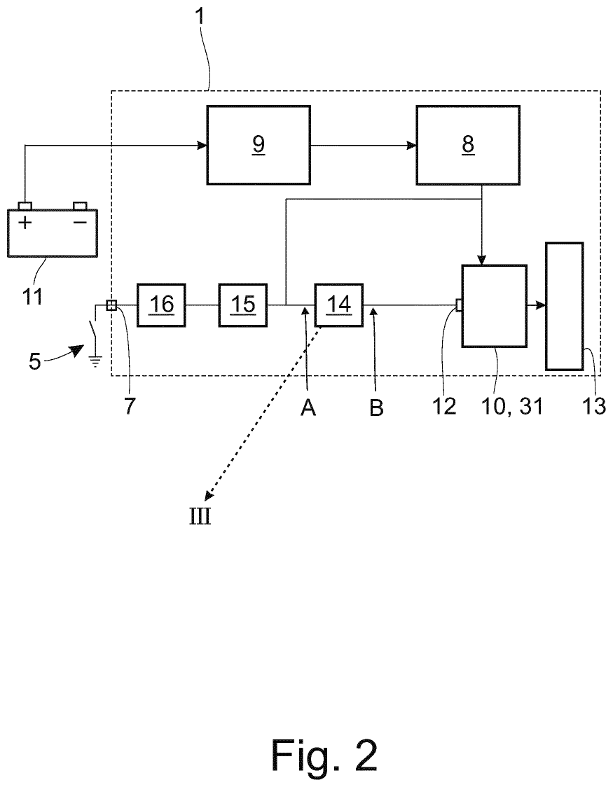

The control arrangement 1 has an electrical energy store 8, which can be configured to be rechargeable. In various embodiments, the control arrangement 1 has a charging circuit 9 for charging the energy store 8. A supply circuit 10 associated with the energy store 8 is provided, the supply circuit 10, during emergency operation in response to the trigger signal being received by the supply circuit 10, providing an emergency supply voltage to the drive 3 via the energy store 8. Emergency operation is, in particular, a situation in which the central battery 11 of the motor vehicle is no longer available for providing a sufficient supply voltage, for example in the case of an insufficient state of charge of the central battery 11 or in the event of a crash. The central battery 11 can be the battery that provides the electrical energy required for starting the motor vehicle and/or for driving operation of the motor vehicle. The supply circuit 10 is designed to provide the emergency voltage for a drive controller 13, which is merely schematically indicated in FIG. 2, in response to receiving the trigger signal, here with the low logic level applied to a control input 12 of the supply circuit 10.

During normal operation however, the supply voltage for the drive 3 can be provided by means of the central battery 11, this not being illustrated further in FIG. 2. It is likewise conceivable for the supply voltage to be provided by means of the energy store 8 and for the energy store 8 to be charged via the charging circuit 9 starting from the supply voltage of the central battery 11 during normal operation too.

In one refinement, the control arrangement 1 is equipped with an operation controller which is designed, for example, for electronically implementing locking states. In principle, the control arrangement 1 can be configured as a door control unit and/or, as illustrated in FIG. 1, as a controller integrated in the motor vehicle locking system 2, for example as a lock controller. It is likewise conceivable for the control arrangement 1 to be part of a central motor vehicle controller.

It is then essential for the control arrangement 1 to have a limiting member 14 for the forwarding of the trigger signal from the operating element 5 to the supply circuit 10, and for the limiting member 14 to be designed to suppress the forwarding of the trigger signal after a maximum actuation time has elapsed following beginning of the trigger signal.

In various embodiments, the limiting member 14 is connected between the connecting input 7 and the control input 12 of the supply circuit 10. Here, “forwarding” of the trigger signal means that, when the trigger signal is present, the limiting member 14 creates a signal to the supply circuit 10, this signal leading to provision of the supply voltage by the supply circuit 10. In the simplest case, the limiting member 14 passes on the trigger signal, here the low logic level, to the control input 12. However, the signal transmitted by the operating element 5 can also be modified or indirectly passed on here. In contrast, “suppression” of the trigger signal is understood to mean that, when the trigger signal is present, the limiting member 14 creates a signal for supply voltage, this signal preventing, in particular ending, provision of the supply voltage by the supply circuit 10. In various embodiments, the limiting member 14 creates, with suppression of the forwarding, a high logic level at the control input 12 of the supply circuit 10, even if a low logic level is still applied to the connecting input 7 with the trigger signal.

The maximum actuation time can be set on the basis of the configuration of the limiting member 14 and in particular can be parameterized, which will be explained further below. The maximum actuation time can be less than 5 s, such as less than 1 s.

A refinement with a low-pass filter 15 and/or diode 16 at the control-end input is additionally provided in FIG. 2.

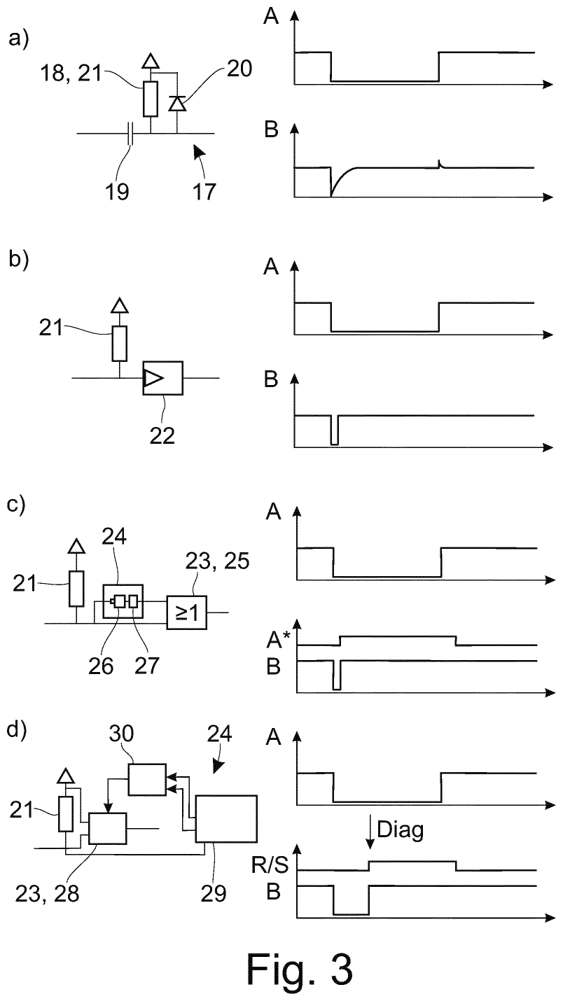

FIGS. 3a) to 3d) show different variants for implementing the limiting member 14. In FIG. 3a) and in various embodiments, provision is made for the limiting member 14 to have at least one filter circuit, such as a high-pass filter 17, for suppressing the trigger signal.

In various embodiments, the high-pass filter 17 is configured as an RC member comprising a resistor 18 and a capacitor 19. With the high-pass filter 17, the signal B provided for supply circuit 10 rises again to the high logic level after the trigger signal A starts, this likewise being schematically shown in FIG. 2a). Other types of filter, which lead to a similar time response, are likewise conceivable. The maximum actuation time can be set by way of the choice of filter circuit, here the limit frequency of the high-pass filter 17.

In various embodiments, a diode 20 is also associated with the high-pass filter 17, this diode suppressing voltage peaks in the signal B when the trigger signal A ends.

In various embodiments, provision is further made for the control arrangement 1 to have a pull-up resistor 21 which provides a high logic level for the supply circuit 10, and for the supply circuit 10 to receive a low logic level with forwarding of the trigger signal.

It can be here when the pull-up resistor 21, as illustrated in FIG. 2, is part of the filter circuit. Here, the pull-up resistor 21 can be formed by the resistor 18 of the RC member of the high-pass filter 17, so that the resistor 18 has a dual function.

It is conceivable for the capacitor 19 to be an electrolytic capacitor which has self-discharging properties, so that the capacitor 19 is discharged after operation has ended. In a further refinement, not illustrated, a discharge circuit for the capacitor 19 is provided, the discharge circuit being provided, for example, parallel to the capacitor 19 and in particular having a high-impedance resistor. As an alternative or in addition, the resistor 18 can be arranged in such a way that discharging of the capacitor 19 via the resistor 18 is rendered possible.

In various embodiments, provision is further made for the limiting member 14 to have a monostable multivibrator 22 which is designed to be moved to an unstable state, in which the forwarding of the trigger signal is allowed by the limiting member 14, when the trigger signal is received, and to fall back to a stable state, in which the forwarding of the trigger signal is suppressed by the limiting member 14, after the maximum actuation time has elapsed.

The monostable multivibrator 22 is triggered here via the trigger signal A and thus transmits the trigger signal A, as signal B, to the supply circuit 10. The maximum actuation time can be set by way of the hold time of the monostable multivibrator 22 here. In particular, the monostable multivibrator 22 is configured such that it cannot be subsequently triggered.

In various embodiments, provision is further made for the limiting member 14 to have a switching element 23 which allows the forwarding of the trigger signal in a first switching state and suppresses the forwarding of the trigger signal in a second switching state, and for a time controller 24 to be provided for actuating the switching element 23, the time controller moving the switching element 23 to the second switching state after the maximum actuation time has elapsed.

Here, the trigger signal A is applied to an input of the switching element 23 and in the first switching state is forwarded as signal B for the supply circuit 10 at the output of the switching element 23. In the second switching state, the forwarding of the trigger signal A is interrupted in particular, so that a high logic level is present here as signal B at the output of the switching element 23.

In FIG. 3c) and in various embodiments, provision is made for the switching element 23 to have a logic member 25 which receives the trigger signal at an input and is interconnected with the time controller 24 at a further input for actuation, and for the output of the logic member 25 to be provided for forwarding the trigger signal.

Here, the suppression of the forwarding can be implemented in a particularly simple manner since the time controller 24 can move the switching element 23 to the second switching state via a simple logic signal.

In the present case, the logic member 25 is illustrated, by way of example, as a simple OR gate which therefore effects activation of the supply voltage only at a low logic level provided by the time controller 24. Here, the time controller 24 passes on the signal A* to the logic member 25 which, after the maximum actuation time, is moved back to the high logic level, in order to suppress the forwarding. Other refinements of the logic member 25 are conceivable.

In various embodiments, provision is further made for the time controller 24 to have a delay circuit, and for the delay circuit to contain at least one logic circuit 26, which has a propagation time configured for providing the maximum actuation time, and/or a delay member 27.

Here, the time controller 24 provides a signal A* that complements the output signal A and has a time delay relative to the output signal A. Here, the delay can be based at least partially on the propagation time of the components of the time controller 24, here the logic circuit 26. The delay member 27, which can have an RC member in particular, can be provided. The maximum actuation time can be set using the properties of the delay member 27. Various components can be used for the logic circuit 26; in a particularly simple refinement a single logic gate, both inputs of which are connected to the connecting input 7, is provided as the logic circuit 26.

According to the refinement illustrated in FIG. 3d), provision is made for the switching element 23 to be configured as a multiplexer 28.

In various embodiments, one of the inputs of the multiplexer 28 is designed for connection to the operating element 5 for transmitting the trigger signal. However, a further input has applied to it a signal which complements the trigger signal, here the high logic level. The time controller 24 actuates the multiplexer 28 for choosing the input in order to implement the suppression after the maximum actuation time has elapsed.

Provision can be made for the control arrangement 1 to have a processor 29, in particular for actuating the drive 3. The processor 29 may be a microprocessor or the like, which can also perform further control functions with respect to the motor vehicle locking system 2, for example the operation controller. The processor 29 can provide at least a portion of the limiting member 14. Here, actuation is provided by the processor 29, the processor 29 in particular at least partially providing the time controller 24 for the switching element 23 using the actuation.

FIG. 3d) shows that the processor 29 actuates the multiplexer 28 for this purpose and implements the maximum actuation time, for example by executing corresponding programming. Actuation of the logic member 25 for the refinement shown in FIG. 3c) by the processor 29 is likewise conceivable.

In a further refinement, the processor 29 can be used for diagnosing the functioning of the operating element 5. For example, when a prespecified maximum duration, such as the maximum actuation time, is exceeded by the duration of the trigger signal, the processor 29 transmits a fault signal to a superordinate control unit, for example to the central motor vehicle controller, for setting a fault memory or the like. For this purpose, the processor 29 can be connected to the connecting input 7 independently of the limiting member 14, this likewise being indicated in FIG. 3d).

In various embodiments, provision is further made for the time controller 24 to have a storage member 30, such as an RC flip-flop, which maintains the actuation of the switching element 23 for suppressing the trigger signal.

In the refinement illustrated in FIG. 3d), the storage member 30 is set by the processor 29 and the multiplexer 28 is actuated on the basis of the state of the storage member 30. If, for example, a continuous trigger signal is present, which is caused by a defective operating element 5 or a defective feed line, after the maximum actuation time has elapsed, the storage member 30 is set to a state with which the multiplexer 28 suppresses the forwarding of the trigger signal. The suppression on the basis of the state of the storage member 30 is maintained until the storage member 30 is reset, even when the processor 29 is deactivated, for example during emergency operation.

In various embodiments, provision is further made for the supply circuit 10 to have a boost converter 31 which can be activated by the trigger signal. The boost converter 31 serves to convert the voltage provided by the energy store 8 into a comparatively higher drive voltage. The energy store 8 can have at least one storage capacitor, the voltage provided by the capacitor being converted into a higher drive voltage by the boost converter 31.

The energy store 8 can have at least one double-layer capacitor. A double-layer capacitor is an electrochemical energy store 8 with an electrochemical double layer. Such a double-layer capacitor is also referred to as a “super capacitor”, “supercap”, or “ultracap”. A double-layer capacitor can provide a high power density for the motor vehicle locking system 2, premature discharging in the case of a faulty trigger signal being prevented by the limiting member 14.

Various embodiments provide a motor vehicle locking system 2 for a motor vehicle having a drive 3 with an electric drive motor 4 for providing a motorized locking function for an adjustable closure element 6 of the motor vehicle and having a control arrangement 1 as proposed.

According to various embodiments, the motor vehicle locking system 2 has a motor vehicle lock 32 for the adjustable closure element 6 of the motor vehicle. The motor vehicle lock 32 is equipped with a lock latch 33, which can pivot about a lock latch axis, for holding engagement with a locking part 34, and a pawl 35, which is assigned to the lock latch 33 and can pivot about a pawl axis. The locking part 34 may be a locking clip, a locking bolt or the like. By way of example, the motor vehicle lock 32 is arranged on the closure element 6, while the locking part 34 is arranged fixed to the body of the motor vehicle.

The pawl 35 can be moved to a dropped position, illustrated in FIG. 1, in which it holds the lock latch 33 in the illustrated locked position. The pawl 35 can also be lifted in a motorized manner by means of the electric drive 3. For this purpose, the drive motor 4 can be connected to the pawl 35 by way of a drive cable 36. The motorized lifting of the pawl 35 in FIG. 1 is pivoting of the pawl 35 clockwise about the pawl axis. The pawl 35 may in principle also be a constituent part of a pawl system consisting of two or more sequentially arranged pawls and associated with the lock latch 33.

In addition to or instead of the locking function of the motor vehicle lock 32 explained in more detail here, the motor vehicle locking system 2 can likewise have a drive arrangement for the motorized adjustment of an abovementioned closure element 6 of the motor vehicle, the drive arrangement being used for motorized adjustment, in particular opening and/or closing, of the closure element 6. Other examples of locking functions are motorized adjustment of operator control elements such as operator control levers and door handles, and of interior elements and exterior elements of the motor vehicle, such as fan elements, interior mirrors, side mirrors, lighting or the like.

Various embodiments provide a method for operating a motor vehicle locking system 2, the motor vehicle locking system 2 having a drive 3 with an electric drive motor 4, the drive 3 being actuated by means of the control arrangement 1 in response to a trigger signal transmitted by an operating element 5 in order to provide a motorized locking function for an adjustable closure element 6 of the motor vehicle, the control arrangement 1 having an electrical energy store 8 and a supply circuit 10 associated with the energy store 8, during emergency operation in response to the trigger signal being received an emergency supply voltage being provided to the drive 3 via the energy store 8 by means of the supply circuit 10.

It is essential here for the control arrangement 1 to have a limiting member 14 for the forwarding of the trigger signal from the operating element 5 to the supply circuit 10, the forwarding of the trigger signal being suppressed by means of the limiting member after a maximum actuation time has elapsed following beginning of the trigger signal.

1. A control arrangement for operating a motor vehicle locking system,
the motor vehicle locking system comprising a drive with an electric drive motor, the control arrangement actuating the drive in response to a trigger signal transmitted by an operating element in order to provide a motorized locking function for an adjustable closure element of the motor vehicle,
the control arrangement comprising an electrical energy store and a supply circuit associated with the energy store, the supply circuit, during emergency operation in response to the trigger signal being received by the supply circuit, providing an emergency supply voltage to the drive via the energy store,
wherein the control arrangement has a limiting member for the forwarding of the trigger signal from the operating element to the supply circuit, and wherein the limiting member is designed to suppress the forwarding of the trigger signal after a maximum actuation time has elapsed following beginning of the trigger signal.

2. The control arrangement as claimed in claim 1, wherein the limiting member has at least one filter circuit for suppressing the trigger signal.

3. The control arrangement as claimed in claim 2, wherein the control arrangement comprises a pull-up resistor which provides a high logic level for the supply circuit, and wherein the supply circuit receives a low logic level with forwarding of the trigger signal.

4. The control arrangement as claimed in claim 1, wherein the limiting member comprises a monostable multivibrator which is designed to be moved to an unstable state, in which the forwarding of the trigger signal is allowed by the limiting member, when the trigger signal is received, and to fall back to a stable state, in which the forwarding of the trigger signal is suppressed by the limiting member, after the maximum actuation time has elapsed.

5. The control arrangement as claimed in claim 1, wherein the limiting member comprises a switching element which allows the forwarding of the trigger signal in a first switching state and suppresses the forwarding of the trigger signal in a second switching state, and wherein a time controller is provided for actuating the switching element, the time controller moving the switching element to the second switching state after the maximum actuation time has elapsed.

6. The control arrangement as claimed in claim 5, wherein the switching element comprises a logic member which receives the trigger signal at an input and is interconnected with the time controller at a further input for actuation, and wherein the output of the logic member is provided for forwarding the trigger signal.

7. The control arrangement as claimed in claim 5, wherein the time controller has a delay circuit, and wherein the delay circuit contains at least one logic circuit, which has a propagation time configured for providing the maximum actuation time, and/or a delay member.

8. The control arrangement as claimed in claim 5, wherein the switching element is configured as a multiplexer.

9. The control arrangement as claimed in claim 1, wherein the control arrangement has a processor, and the processor provides or actuates the limiting member.

10. The control arrangement as claimed in claim 5, wherein the time controller comprises a storage member, which maintains the actuation of the switching element for suppressing the trigger signal.

11. The control arrangement as claimed in claim 1, wherein the supply circuit comprises a boost converter which can be activated by the trigger signal.

12. A motor vehicle locking system for a motor vehicle having a drive with an electric drive motor for providing a motorized locking function for an adjustable closure element of the motor vehicle and having a control arrangement as claimed in claim 1.

13. A method for operating a motor vehicle locking system, the motor vehicle locking system comprising a drive with an electric drive motor, the drive being actuated by the control arrangement in response to a trigger signal transmitted by an operating element in order to provide a motorized locking function for an adjustable closure element of the motor vehicle,
the control arrangement comprising an electrical energy store and a supply circuit associated with the energy store, during emergency operation in response to the trigger signal being received an emergency supply voltage being provided to the drive via the energy store by the supply circuit,
wherein the control arrangement comprises a limiting member for the forwarding of the trigger signal from the operating element to the supply circuit, the forwarding of the trigger signal being suppressed by the limiting member after a maximum actuation time has elapsed following beginning of the trigger signal.

14. The control arrangement as claimed in claim 1, wherein the at least one filter circuit comprises a high-pass filter.

15. The control arrangement as claimed in claim 1, wherein the pull-up resistor is part of the filter circuit.

16. The control arrangement as claimed in claim 9, wherein the processor at least partially provides the time controller for the switching element.

17. The control arrangement as claimed in claim 10, wherein the storage member comprises an RC flip-flop.

18. The control arrangement as claimed in claim 11, wherein the energy store has at least one storage capacitor,

19. The control arrangement as claimed in claim 18, wherein the at least one storage capacitor comprises at least one double-layer capacitor.
